(19) United States
(12) Patent Application Publication
(10) Pub. No.: US 2021/0026185 A1
(43) Pub. Date: Jan. 28, 2021

(54) DISPLAY PANEL

(71) Applicants: HKC CORPORATION LIMITED, Shenzhen, Guangdong (CN); CHONGQING HKC OPTOELECTRONICS TECHNOLOGY CO., LTD., Chongqing (CN)

(72) Inventor: Peihsin LIN, Chongqing (CN)

(21) Appl. No.: 17/044,251

(22) PCT Filed: Sep. 11, 2018
(86) PCT No.: PCT/CN2018/105067

§ 371 Date: Sep. 30, 2020

(30) Foreign Application Priority Data
Jul. 17, 2018 (CN) 201810784565.1

(51) Int. Cl. G02F 1/1333; G02F 1/1339; G02F 1/133

(52) U.S. Cl. CPC G02F 1/133308; G02F 1/13306; G02F 1/1339

(57) ABSTRACT

Disclosed is a display panel, including: a first substrate, a second substrate, a gate driver circuit structure, a display area structure, a frame seal structure, and liquid crystal. The first substrate and the second substrate are combined to form a panel area; the panel area includes a gate circuit area and a display area. A gate driver circuit structure is disposed on the first substrate in the gate circuit area, and a display area structure is disposed on the first substrate in the display area. The frame seal structure is disposed in the panel area, connects the first substrate and the second substrate, and isolates the gate circuit area and the display area. The liquid crystal is filled in the display area. The display panel of the present disclosure not only saves the amount of liquid crystal, but also effectively reduces the resistance-capacitance load of the display panel, further reducing the energy consumption of the panel, and less likely to generate bubbles when filling the liquid crystal.

### CROSS-REFERENCE TO RELATED DISCLOSURES

The present disclosure is the National Stage of International Application No. PCT/CN2018/105067, filed Sep. 11, 2018, which claims the benefit of Chinese Patent Application No. 201810784565.1, filed Jul. 17, 2018 with the National Intellectual Property Administration and entitled “DISPLAY PANEL”, the entirety of which is hereby incorporated herein by reference.

### TECHNICAL FIELD

The present disclosure relates to a display panel, and more particularly relates to a display panel for array substrate type driving technology.

### BACKGROUND

To save costs, the gate driver on array (GOA) technology has been widely applied to display panels, such as liquid crystal display panels. The liquid crystal display panel is driven by a source driver chip (Source IC) and a gate driver chip (Gate IC). The former one controls voltages for transmitting signals, and the latter one uses a transistor as a switch to control and determine amount of light transmission.

The gate driver on array is the technology that a gate driver circuit structure is directly formed on a glass substrate of liquid crystal display panel, instead of using the gate driver chip. The gate driver circuit structure is formed by an exposure and development manner to produce a logic circuit at the edge of the glass substrate. Thus, cost is reduced due to the materials used and the manufacturing process; besides, the liquid crystal display is enabled to have a narrower border.

In addition, color filter on TFT (COT) technology from NEC company is the manufacturing technology in which a color-resistance module is disposed on a lower plate instead of being on an upper plate. The color filter on TFT technology improves pixel aperture ratio, and reduces the occurrence of movable Mura. Thus, the liquid display applying the gate driver on array technology with the color filter on TFT technology will be a mainstream in the future.

However, in the related art, the substrates such as a upper glass substrate and a lower glass substrate are combined by a frame seal structure, and accordingly the gate driver circuit structure and the display area structure are enclosed. Thus, after filling the liquid crystal (LC), the liquid crystal is full of the position where a display area structure and a gate driver circuit structure are located, which not only wastes the liquid crystal, but also increases the resistance-capacitance loading (RC loading) and the energy consumption of the display panel.

Moreover, the shape and the flatness of the surfaces of the display area structure and the gate driver circuit structure are different after arranging the display area structure and the gate driver circuit structure on the substrate. During filling the liquid crystal, the difference of the surface shape generally causes poor diffusion of the liquid crystal, thereby producing air bubbles in the edge area.

Hence, in the array substrate type driving technology, the problems to be solved by those skilled in the art with are how to save the costs of the liquid crystal, how to reduce the resistance-capacitance load and the energy consumption of the panel, as well as how to avoid the generation of air bubbles during filling the liquid crystal.

### SUMMARY

The present disclosure provides a display panel, which can not only saves the amount of liquid crystal, but also effectively reduces the resistance-capacitance load of the display panel, and further reduces the energy consumption of the panel, and is less likely to generate bubbles when filling the liquid crystal.

One embodiment of the present disclosure provides a display panel. The display panel includes a first substrate, at least one gate driver circuit structure, a display area structure, and a frame seal structure.

The gate driver circuit structure is disposed on the first substrate. The display area structure is also disposed on the first substrate. The frame seal structure is disposed on the first substrate, and isolates the gate driver circuit structure and the display area structure.

For the display panel as described above, the display panel further includes a second substrate. The second substrate and the first substrate sandwich the gate driver circuit structure, the display area structure, and the frame seal structure. The frame seal structure is also disposed to connect to the second substrate, and isolates a space between the first substrate and the second substrate where the gate driver circuit structure is located and a space between the first substrate and the second substrate where the display area structure.

The display panel further includes liquid crystal. The liquid crystal is disposed in a space between the first substrate and the second substrate where the display area structure is located.

Further, the display panel may include two gate driver circuit structures. The two gate driver circuit structures are disposed on two opposite sides of the display area structure.

The present disclosure provides an embodiment of the frame seal structure. The frame seal structure further includes a first frame seal and a second frame seal. The first frame seal surrounds the periphery of the display area structure, and is disposed between the two gate driver circuit structures. The second frame seal surrounds the periphery of the two gate driver circuit structures. The first frame seal isolates gate driver circuit structure and the display area structure.

The present disclosure provides another embodiment of the frame seal structure. The display panel includes two gate driver circuit structure. The two gate driver circuit structure are disposed on two opposite sides of the display area structure. The frame seal structure further includes two first frame seals and a second frame seal. The second frame seal surrounds the periphery of the two gate driver circuit structures. The two first frame seals are respectively disposed between the two gate driver circuit structures and the display area structure. The first frame seal isolates gate driver circuit structure and the display area structure.

The present disclosure provides another embodiment of the frame seal structure. The display panel includes two gate driver circuit structures. The two gate driver circuit structures are disposed on two opposite sides of the display area structure. The first frame seal structure covers the two gate driver circuit structure.

The present disclosure provides an embodiment of the display panel. The display panel includes a first substrate, a second substrate, a gate driver circuit structure, a display area structure, a frame seal structure and liquid crystal.

The first substrate and the second substrate are combined to form a panel area. The panel area includes a gate circuit area and a display area. The gate circuit area has a gate driver circuit structure disposed on the first substrate, and the display area has a display area structure disposed on the first substrate.

The frame seal structure is disposed in the panel area, connects to the first substrate and the second substrate, and isolates the gate circuit area and the display area. The liquid crystal is filled in the display area.

Further, the display panel may include two gate driver circuit structures. The two gate driver circuit structures are disposed on two opposite sides of the display area structure.

The present disclosure provides an embodiment of the frame seal structure. The frame seal structure further includes a first frame seal and a second frame seal. The first frame seal surrounds the periphery of the display area structure, and is disposed between the two gate driver circuit structures. The second frame seal surrounds the periphery of the two gate driver circuit structures. The first frame seal isolates gate driver circuit structure and the display area structure.

The present disclosure provides another embodiment of the frame seal structure. The display panel includes two gate driver circuit structure. The two gate driver circuit structure are disposed on two opposite sides of the display area structure. The frame seal structure further includes two first frame seals and a second frame seal. The second frame seal surrounds the periphery of the two gate driver circuit structures. The two first frame seals are respectively disposed between the two gate driver circuit structures and the display area structure. The first frame seal isolates gate driver circuit structure and the display area structure.

The present disclosure provides an embodiment of the display panel. The display panel includes a first substrate, a second substrate, a gate driver circuit structure, a display area structure, a frame seal structure and liquid crystal.

The first substrate and the second substrate are combined to form a panel area, the panel area includes a gate circuit area and a display area. The gate circuit area has a gate driver circuit structure disposed on the first substrate, and the display area has a display area structure disposed on the first substrate.

The frame seal structure is disposed in the gate driver circuit structure. The frame seal structure covers the gate driver circuit structure, and connects to the first substrate and the second substrate. The liquid crystal is limited with the frame seal structure, and filled in the display area structure.

Therefore, the display panel implemented by the embodiment according to the present disclosure uses the improved frame seal structure, which not only saves the amount of liquid crystal, but also effectively reduces the resistance-capacitance load of the display panel, further reducing the energy consumption of the panel, and less likely to generate bubbles when filling the liquid crystal.

The above description is only an overview of the technical solutions of the present disclosure, to make the technical solutions of the present disclosure more clearly, so as to be implemented in accordance with the contents of the specification, and to make the above and other objectives, features and advantages of the present disclosure more clearly, the following is a detailed description of preferred embodiments, with reference to the accompanying drawings.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the text to explain the principle of the present disclosure. Obviously, the drawings in the following description are merely some of the embodiments of the present disclosure, and those skilled in the art can obtain other drawings according to the structures shown in the drawings without any creative work. In the drawings:

FIG. 1 is a top view of the display panel according to the present disclosure.

FIG. 2 is a side cross-sectional view of the display panel according to the present disclosure.

FIG. 3 is a illustrative view of the frame seal structure applied to the display panel of an embodiment according to the present disclosure.

FIG. 4 is a illustrative view of the frame seal structure applied to the display panel of another embodiment according to the present disclosure.

FIG. 5 is a illustrative view of the frame seal structure applied to the display panel of another embodiment according to the present disclosure.

FIG. 6 is a side cross-sectional view of the display panel of another embodiment according to the present disclosure.

### DETAILED DESCRIPTION OF THE EMBODIMENTS

The specific structural and functional details disclosed herein are merely representative and are for purposes of describing exemplary embodiments of the present disclosure. However, exemplary embodiments of the present disclosure may, however, be embodied in many different forms, and should not be construed as limited to the embodiments set forth herein.

In the description of the present disclosure, it should be understood that, the orientation or positional relationship indicated by the term, such as “center”, “horizontal”, “upper”, “lower”, “left”, “right”, “vertical”, “horizontal”, “top”, “bottom”, “inside” and “outside”, is based on the orientation or positional relationship shown in the drawings, which is merely for the convenience of the description of the present disclosure, and is not intended to indicate or imply that the apparatus or component referred to must have a particular orientation, or be constructed and operated in a particular orientation, thus could not be interpreted as a limitation to the present disclosure. In addition, terms such as “first” and “second” are used herein for purposes of description and are not intended to indicate or imply relative importance or to imply the number of indicated technical features. Thus, the features defined with “first” and “second” may comprise or imply at least one of these features. In the description of the present disclosure, “a plurality of” means two or more than two, unless specified otherwise. Moreover, the term “comprises”, or any other variations thereof, are intended to cover a non-exclusive inclusion.

In the present disclosure, unless specified or limited otherwise, the terms “connected”, “fixed” and the like are used broadly, and may be, for example, fixed connections, detachable connections, or integral connections; may also be mechanical or electrical connections; may also be direct connections or indirect connections via intervening structures; may also be inner communications of two elements or interactions of two elements, which could be understood by those skilled in the art according to specific situations.

The terminology used herein is for the purpose of describing particular embodiments only, and is not intended to limit the scope of the present disclosure. The singular form, such as “a”, “an”, is intended to include the plural form, unless the context clearly indicates otherwise. It should also be understood that, the terms “comprises”, “includes”, are intended to mean the existence of the recited features, integers, steps, operations, units and/or components, and do not exclude the presence or addition of one or more other features, integers, steps, operations, units, components and/or combinations thereof.

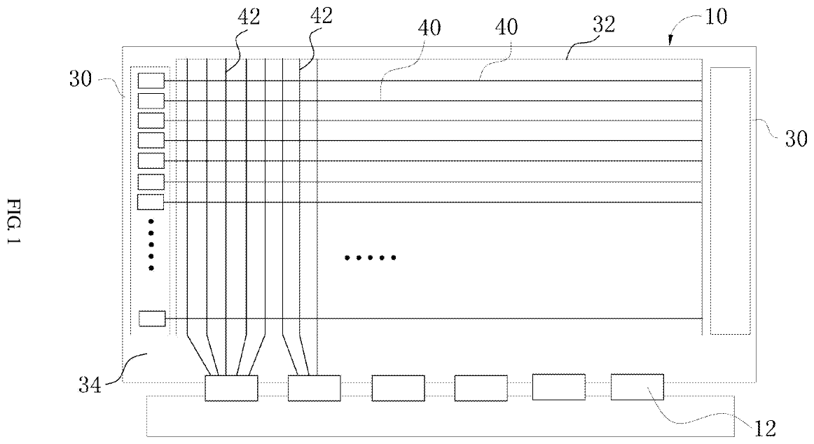

Referring to FIG. 1, FIG. 1 is a top view of the display panel according to the present disclosure. One embodiment of the present disclosure provides a display panel 10, such as a liquid display panel applied to gate driver on array (GOA) technology. The display panel 10 has a plurality of parallel rows of gate lines 40 and a plurality of parallel columns of data lines 42. By the gate lines 40 and the data lines 42, arrangement state of liquid crystal 38 is under control, so as to generate screen image. And the circuit structure, in which the gate lines 40 are interleaved with the data lines 42 and capable of displaying pictures, has a plurality of transistors 52 in an array arrangement, which is called a display area 32. The display area structure 32 is disposed on a first substrate 34.

The display panel 10 as shown has a source driver chip 12. The source driver chip 12 is configured to drive the data line 42. But different from the prior art, the gate driver on array technology discards a gate driver chip, and instead, a gate driver circuit structure 30 is directly disposed on the first substrate 34. The first substrate 34 is, for example, a glass substrate, and the gate line 40 is driven by the gate driver circuit structure 30.

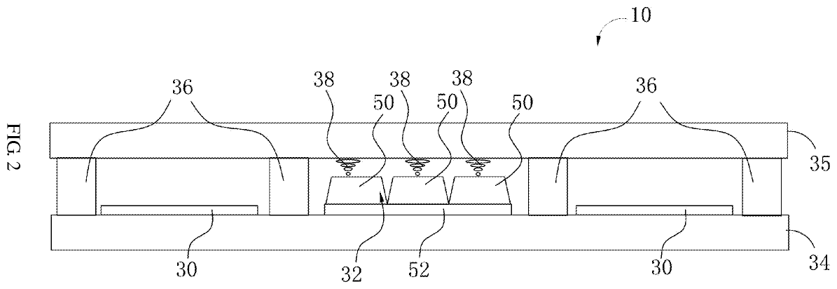

Referring to FIG. 2, FIG. 2 is a side cross-sectional view of the display panel according to the present disclosure. The display panel 10, in addition to the first substrate 34, the gate driver circuit structure 30, and the display area structure 32, further includes a second substrate 35, a frame seal structure 36 and liquid crystal 38.

The second substrate 35 and the first substrate 34 sandwich the gate driver circuit structure 30, the display area structure 32, and the frame seal structure 36.

The color filter on TFT (COT) technology could be applied on the transistor 52, therefore, as shown, the color resistance-capacitance module 50 is disposed on the top of the transistor 52 on the first substrate 34. The color resistance-capacitance module 50 may include a red color resisting module 50, a green color resisting module 50, and a blue color resisting module 50. The red color resisting module 50, the green color resisting module 50, and the blue color resisting module 50 form a pixel unit, and the entire image is composed of a plurality of pixel units in an array arrangement. For clarity, the drawing only illustrates the red color resisting module 50, the green color resisting module 50, and the blue color resisting module 50 of one pixel unit for description.

The frame seal structure 36 is also disposed between the second substrate 35 and the first substrate 34, connects to the second substrate 35 and the first substrate 34, and isolates a space between the first substrate 34 and the second substrate 35 where the gate driver circuit structure 30 is located, and a space between the first substrate 34 and the second substrate 35 where the display area structure 32 is located, further isolating the gate driver circuit structure 30 and the display area structure 32.

The liquid crystal 38 is disposed in a space between the first substrate 34 and the second substrate 35 where the display area structure 32 is located. Therefore, by the isolation of the frame seal structure 36, the space, between the first substrate 34 and the second substrate 35 where the gate driver circuit structure 30 is located, is in a vacuum state as shown, and the liquid crystal 38 is only filled in the space between the first substrate 34 and the second substrate 35 where the display area structure 32 is located.

The plane-parallel capacitor formula is C=ε₀εᵣA/d, ε₀ is a dielectric coefficient in vacuum, εᵣ is a dielectric coefficient of the material. According to the plane-parallel capacitor formula C=ε₀εᵣA/d, in the prior art, the liquid crystal 38 is expanded to the entire display area structure 32 and the gate driver circuit structure 30, the capacitance value of the display panel 10 is ε₀εᵣA/d. However, in the present disclosure, the liquid crystal 38 is only filled in the display area structure 32, so the capacitance value of the display panel 10 is ε₀A/d.

As such, the display panel 10 implemented according to the present disclosure, uses the improved frame seal structure 36, which not only saves the amount of liquid crystal 38, but also effectively reduces the resistance-capacitance load of the display panel 10, further reducing the energy consumption of the panel. In addition, because the structure flatness of the filling range is consistent, bubbles are less likely to occur when the liquid crystal 38 is filled.

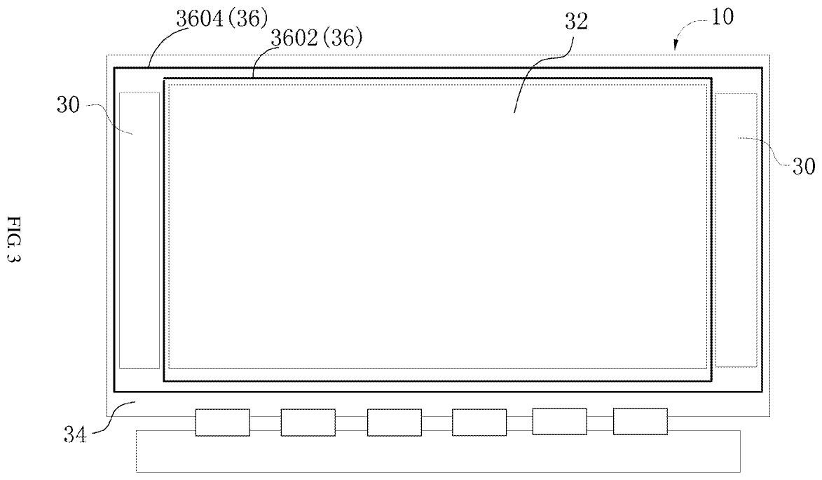

One embodiment of the frame seal structure 36 is provided in the present disclosure, referring to FIG. 3, FIG. 3 is a illustrative view of the frame seal structure applied to the display panel of an embodiment according to the present disclosure. For the display panel 10 as described above, the display panel 10 includes two gate driver circuit structures 30, and the two gate driver circuit structures 30 are disposed on two opposite sides of the display area structure 32.

The frame seal structure 36 further includes a first frame seal 3602, and a second frame seal 3604. The first frame seal 3602 surrounds the periphery of the display area structure 32, and disposed between the two gate driver circuit structures 30. The second frame seal 3604 surrounds the periphery of the two gate driver circuit structures 30. The first frame seal 3602 isolates the gate driver circuit structures 30 and the display area structure 32.

In this case, the liquid crystal 38 could be limited in the area where the display area structure 32 is located by the first frame seal 3602.

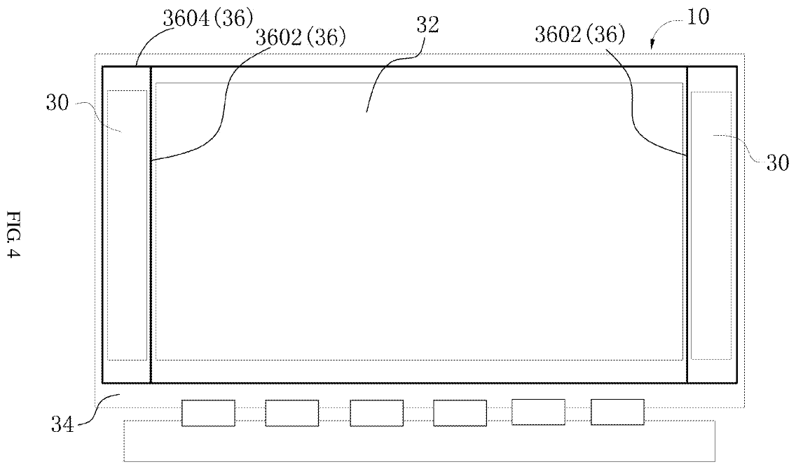

Another embodiment of the frame seal structure 36 is provided in the present disclosure, referring to FIG. 4, FIG. 4 is a illustrative view of the frame seal structure applied to the display panel of another embodiment according to the present disclosure. For the display panel 10 as described above, the display panel 10 also includes two gate driver circuit structures 30, and the two gate driver circuit structures 30 are disposed on two opposite sides of the display area structure 32.

The frame seal structure 36 further includes two first frame seals 3602, and second frame seal 3604. The second frame seal 3604 surrounds the periphery of the two gate driver circuit structures 30. The two first frame seals 3602 are respectively disposed between the two gate driver circuit structures 30 and the display area structure 32, and two ends of the first frame seal 3602 are respectively connected to two opposite portions of the second frame seal 3604. The first frame seal 3602 isolates gate driver circuit structure 30 and the display area structure 32.

In this case, the liquid crystal 38 could be limited between the two first frame seals 3602, and located in the area where the display area structure 32 is located.

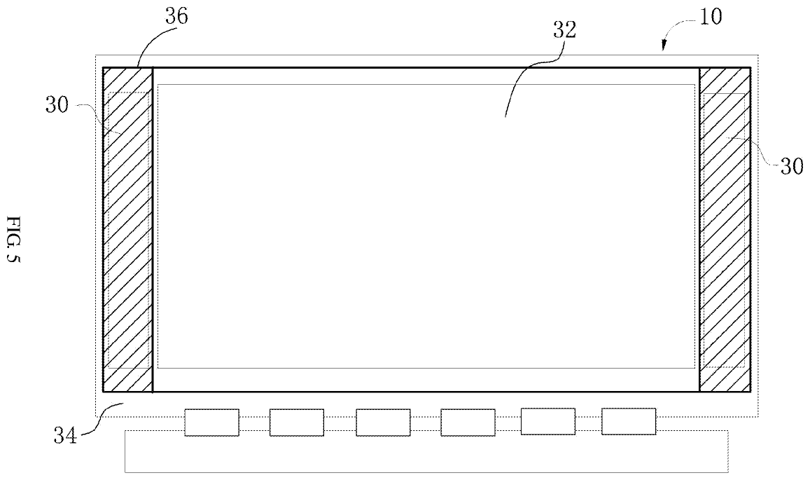

Another embodiment of the frame seal structure 36 is provided in the present disclosure, referring to FIG. 5, FIG. 5 is a illustrative view of the frame seal structure applied to the display panel of another embodiment according to the present disclosure. For the display panel 10 as described above, the display panel 10 includes two gate driver circuit structures 30, and the two gate driver circuit structures 30 are disposed on two opposite sides of the display area structure 32.

The frame seal structure 36 covers the two gate driver circuit structures 30, or it may be called that the first frame seal 3602 of the frame seal structure 36 covers the two gate driver circuit structures 30. That is, the frame seal structure 36 and the first substrate 34 wrap the gate driver circuit structure 30, and the frame seal structure 36 surrounds the periphery of the display area structure 32 and the two gate driver circuit structures 30. In this case, the liquid crystal 38 could be confined and limited by the frame seal structure 36, and located in the area where the display area structure 32 is located.

Another embodiment of the display panel 10 is provided in the present disclosure. Referring to FIGS. 1-2, the display panel 10 related in the present disclosure includes a first substrate 34, a second substrate 35, a gate driver circuit structure 30, a display area structure 32, a frame seal structure 36, and liquid crystal 38.

The first substrate 34 and the second substrate 35 are combined to form a panel area, and the panel area includes a gate circuit area and a display area. The gate circuit area has a gate driver circuit structure 30 disposed on the first substrate 34, and the display area has a display area structure 32 disposed on the first substrate 34.

The frame seal structure 36 is disposed in the panel area, connects to the first substrate 34 and the second substrate 35, and isolates the gate circuit area and the display area. The liquid crystal 38 is filled in the display area.

As such, the display panel 10 of this embodiment according to the present disclosure, uses the improved frame seal structure 36, which not only saves the amount of liquid crystal 38, but also effectively reduces the resistance-capacitance load of the display panel 10, further reducing the energy consumption of the panel, and less likely to generate bubbles when the liquid crystal 38 is filled.

Referring to FIG. 3, for the display panel 10 as described above, the display panel 10 includes two gate driver circuit structures 30, and the two gate driver circuit structures 30 are disposed on the two opposite sides of the display area structure 32.

The frame seal structure 36 further includes a first frame seal 3602, and a second frame seal 3604. The first frame seal 3602 surrounds the periphery of the display area, and disposed between the two gate driver circuit structures 30. The second frame seal 3604 surrounds the periphery of the gate circuit area. In this case, the first frame seal 3602 isolates the gate driver circuit structures 30 and the display area structure 32.

Therefore, the liquid crystal 38 is able to be limited in the area where the display area structure 32 is located by the first frame seal 3602, that is, limited in the panel area.

Another embodiment of the frame seal structure 36 is provided in the present disclosure. Referring to FIG. 4, for the display panel 10 as described above, the display panel 10 also includes two gate driver circuit structures 30, the two gate driver circuit structures 30 are disposed on two opposite sides of the panel area.

The frame seal structure 36 further includes two first frame seals 3602, and a second frame seal 3604. The second frame seal 3604 surrounds the periphery of the gate circuit area and the display area. The two first frame seals 3602 are respectively disposed between the two gate driver circuit structures 30 and the display area structure 32, and two ends of the first frame seal 3602 connect to the two opposite portions of the second frame seal 3604. In this case, the first frame seal 3602 could isolate the gate circuit area and the display area, namely isolate the gate driver circuit structure 30 and the display area structure 32.

Therefore, the liquid crystal 38 could be limited between the two first frame seals 3602, and only filled in the display area, that is, only located in the area where the display area structure 32 is located.

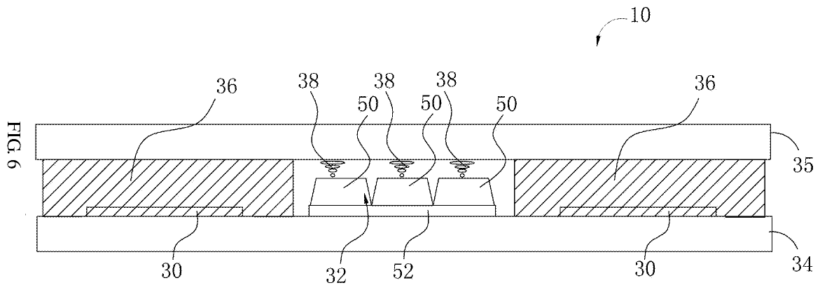

Another embodiment of the display panel 10 is provided in the present disclosure. Referring to FIG. 6 with FIG. 1, FIG. 6 is a side cross-sectional view of the display panel of another embodiment according to the present disclosure. The display panel 10 related in the present disclosure includes a first substrate 34, a second substrate 35, a gate driver circuit structure 30, a display area structure 32, a frame seal structure 36, and liquid crystal 38.

The first substrate 34 and the second substrate 35 are combined to form a panel area, and the panel area includes a gate circuit area and a display area. The gate circuit area has a gate driver circuit structure 30 disposed on the first substrate 34, and the display area has a display area structure 32 disposed on the first substrate 34.

The frame seal structure 36 is disposed in the gate circuit area. The frame seal structure 36 covers the gate driver circuit structure 30, and connects to the first substrate 34 and the second substrate 35, that is, the frame seal structure 36 and the first substrate 34 wrap the gate driver circuit structure 30. The liquid crystal 38 is limited by the frame seal structure 36, and only filled in the display area.

In this case, the liquid crystal 38 could be confined and limited by the frame seal structure 36, and located in the area where the display area structure 32 is located.

In summary, the display panel 10 of the embodiment according to the present disclosure, uses the improved frame seal structure 36, which not only saves the amount of liquid crystal 38, but also effectively reduces the resistance-capacitance load of the display panel 10, further reducing the energy consumption of the panel, and less likely to generate bubbles when the liquid crystal 38 is filled.

The foregoing are only illustrative embodiments in accordance with the present disclosure and therefore not intended to limit the patentable scope of the present disclosure. Any equivalent structure or flow transformations that are made taking advantage of the specification and accompanying drawings of the disclosure and any direct or indirect applications thereof in other related technical fields are within the protection scope of the present disclosure.

What is claimed is:

1. A display panel, comprising:
a first substrate;
at least one driver circuit structure, arranged on the first substrate;
a display area structure, arranged on the first substrate; and
a frame seal structure, the frame seal structure comprising a first frame seal and a second frame seal arranged on the first substrate, the first frame seal isolating the driver circuit structure and the display area structure, the second frame seal surrounding a periphery of the driver circuit structure.

2. The display panel of claim 1, wherein the display panel further comprises a second substrate, the second substrate and the first substrate sandwich the driver circuit structure, the display area structure, and the frame seal structure;
the frame seal structure is also arranged to connect to the second substrate, and isolates a space between the first substrate and the second substrate where the driver circuit structure is located and a space between the first substrate and the second substrate where the display area structure is located.

3. The display panel of claim 2, wherein the display panel further comprises liquid crystal;
the liquid crystal is only arranged in the space between the first substrate and the second substrate where the display area structure is located.

4. The display panel of claim 1, wherein the driver circuit structure is a gate driver circuit structure, the display panel comprises two gate driver circuit structures, the two gate driver circuit structures are arranged on two opposite sides of the display area structure;
the first frame seal surrounds a periphery of the display area structure, and is arranged between the two gate driver circuit structures;
the second frame seal surrounds a periphery of the two gate driver circuit structures, wherein the first frame seal isolates the gate driver circuit structure and the display area structure.

5. The display panel of claim 4, wherein the first frame seal and the second frame seal are separated from each other.

6. The display panel of claim 5, wherein the display panel further comprises liquid crystal;
the liquid crystal is only arranged in the space between the first substrate and the second substrate where the display area structure is located.

7. The display panel of claim 1, wherein the driver circuit structure is a gate driver circuit structure, the display panel comprises two gate driver circuit structures, the two gate driver circuit structures are arranged on two opposite sides of the display area structure;
the second frame seal surrounds a periphery of the two gate driver circuit structures, two of the first frame seals are respectively arranged between the two gate driver circuit structures and the display area structure, wherein the first frame seal isolates the gate driver circuit structure and the display area structure.

8. The display panel of claim 7, wherein the display panel further comprises liquid crystal;
the liquid crystal is only arranged in the space between the first substrate and the second substrate where the display area structure is located.

9. The display panel of claim 1, wherein the driver circuit structure is a gate driver circuit structure, the display panel comprises two gate driver circuit structures, the two gate driver circuit structures are arranged on two opposite sides of the display area structure, the first frame seal covers the two gate driver circuit structures.

10. The display panel of claim 9, wherein the display panel further comprises liquid crystal;
the liquid crystal is only arranged in the space between the first substrate and the second substrate where the display area structure is located.

11. A display panel, comprising:
a first substrate;
a second substrate, the first substrate and the second substrate being combined to form a panel area, the panel area comprising
a gate circuit area, having a gate driver circuit structure arranged on the first substrate, and
a display area, having a display area structure arranged on the first substrate;
a frame seal structure, the frame seal structure further comprising a first frame seal and a second frame seal arranged in the panel area, connecting the first substrate and the second substrate, the first frame seal isolating the gate circuit area and the display area, the second frame seal surrounding a periphery of the driver circuit structure; and
liquid crystal, the liquid crystal being filled in the display area.

12. The display panel of claim 11, wherein the display panel comprises two gate driver circuit structures, the two gate driver circuit structures are arranged on two opposite sides of the display area structure; the frame seal further comprises a first frame seal and a second frame seal, the first frame seal surrounds a periphery of the display area structure, and is arranged between the two gate driver circuit structures, the second frame seal surrounds a periphery of the two gate driver circuit structures, wherein the first frame seal isolates the gate driver circuit structure and the display area structure.

13. The display panel of claim 12, wherein the first frame seal and the second frame seal are separated from each other.

14. The display panel of claim 11, wherein the display panel comprises two gate driver circuit structures, the two gate driver circuit structures are arranged on two opposite sides of the display area structure; the frame seal further comprises two first frame seals and a second frame seal, the second frame seal surrounds a periphery of the two gate driver circuit structures, and the two first frame seals are respectively arranged between the two gate driver circuit structures and the display area structure, wherein the first frame seal isolates the gate driver circuit structure and the display area structure.

15. The display panel of claim 11, wherein the display panel comprises two gate driver circuit structures, the two gate driver circuit structures are arranged on two opposite sides of the display area structure; the frame seal further comprises two first frame seals and a second frame seal, the second frame seal surrounds a periphery of the two gate driver circuit structures, and the two first frame seals covers the two gate driver circuit structures.

16. The display panel of claim 11, wherein the liquid crystal is only filled in the display area.

17. A display panel, comprising:
a first substrate;
a second substrate, the first substrate and the second substrate being combined to form a panel area, the panel area comprising:
a gate circuit area, having a gate driver circuit structure arranged on the first substrate, and
a display area, having a display area structure arranged on the first substrate;
a frame seal structure, arranged in the gate circuit area, the frame seal structure covering the gate driver circuit structure, and connecting the first substrate and the second substrate; and
liquid crystal, the liquid crystal being limited by the frame seal structure, and filled in the display area.

18. The display panel of claim 17, wherein the gate circuit area comprises two gate driver circuit structures, the two gate driver circuit structures are arranged on two opposite sides of the display area structure.

19. The display panel of claim 18, wherein the frame seal further comprises two first frame seals and a second frame seal;
the second frame seal surrounds a periphery of the two gate driver circuit structures, and the two first frame seals covers the two gate driver circuit structures.
